(19) United States
(12) Patent Application Publication
(10) Pub. No.: US 2023/0417948 A1
(43) Pub. Date: Dec. 28, 2023

(54) SYSTEM, APPARATUS AND PROCESSING METHOD SUITABLE FOR ANALYTICS BASED ON GEOLOGY AND GEOPHYSICS DATA AND/OR COMPLETION DATA

(71) Applicant: PETROLIAM NASIONAL BERHAD (PETRONAS), Kuala Lumpur (MY)

(72) Inventors: Junghun LEEM, Kuala Lumpur (MY); Chee Phuat TAN, Kuala Lumpur (MY); Muhamad Fakharuddin Bin CHE YUSOFF, Kuala Lumpur (MY); Zahidah MD ZAIN @ MD DIN, Kuala Lumpur (MY); Iftikhar ALTAF, Kuala Lumpur (MY); Abd Hakim MAZELI, Kuala Lumpur (MY); Budi P. KANTAATMADJA, Kuala Lumpur (MY)

(21) Appl. No.: 18/037,494

(22) PCT Filed: Nov. 18, 2021
(86) PCT No.: PCT/MY2021/050103

§ 371 Date: May 17, 2023

(30) Foreign Application Priority Data
Nov. 20, 2020 (MY) PI2020006117

(51) Int. Cl. G01V 99/00

(52) U.S. Cl. CPC G01V 99/005

(57) ABSTRACT

There is provided an apparatus which can include a first module which can be configured to receive at least one input signal and/or generate at least one input signal. The input signal(s) can include geology and geophysics (G&G) based data and completion data. Completion data can, for example, be associated with a structure. The first module can be further configured to receive at least one reference signal and/or generate at least one reference signal. The apparatus can further include a second module which can be coupled to the first module. The second module can be configured to process the input signal and the reference signal by manner of normalizing the reference signal based on G&G data and/or normalizing the reference signal based on completion data so as to produce at least one output signal corresponding to at least one normalized reference signal.

### REFERENCE TO RELATED APPLICATIONS

The present application is a U.S. national phase of PCT International Patent Application No. PCT/MY2021/050103, filed Nov. 18, 2021, which claims priority to Malaysian Patent Application No. PI2020006117, filed Nov. 20, 2020, both of which are incorporated herein by reference in their entireties.

### FIELD OF INVENTION

The present disclosure generally relates to a system suitable for analytics taking into account one or both of geology and geophysics (G&G) based data (e.g., data concerning/associated with natural environment such as physical properties of earth or rock formation) and completion data (e.g., data associated with a completed structure such as an oil well). The present disclosure further relates to one or both of an apparatus and a processing method associable to the system.

### BACKGROUND

In petroleum engineering industry, it is generally useful to identify/predict parameter(s) which can be helpful for optimization and/or design (e.g., in association with placement of a structure which can be, for example, a well such as an oil well). Examples of parameters can include in-situ rock stress, modulus of elasticity, leak-off coefficient, formation porosity.

Whilst G&G and/or the previous data (e.g., associated with completed wells) can be used for the abovementioned identification/prediction, the present disclosure contemplates that optimization and/or design based on G&G and/or previous data may not be comprehensive/efficient, and therefore not ideal.

The present disclosure contemplates that there is a need for improvement in regard to the aforementioned optimization and/or design.

### SUMMARY OF THE INVENTION

In accordance with an aspect of the disclosure, there is provided an apparatus.

The apparatus can include a first module and a second module, in accordance with an embodiment of the disclosure. The apparatus can, in accordance with an embodiment, further include a third module. The first module can be coupled to the second module. The second module can be coupled to the third module.

Moreover, the apparatus can be coupled to one or more devices, in accordance with an embodiment of the disclosure.

The first module can be configured to one or both of receive and generate one or more input signals. The first module can be further configured to one or both of receive and generate one or more reference signals. The input signal(s) can, for example, include one or both of geology and geophysics (G&G) based data and completion data. The completion data can be associated with a structure. In one embodiment, the reference signal(s) can include production data associable with the structure. The structure can, for example, correspond to a completed structure such as a completed oil-well.

The second module can be configured to process the input signal(s) and the reference signal(s) by manner of one or both of:
normalizing the reference signal based on G&G data, and
normalizing the reference signal based on completion data,
   to produce at least one output signal corresponding to one or more normalized reference signals.

The present disclosure contemplates that, in one embodiment, the output signal(s) can be based solely on normalization of the reference signal(s) with respect to (i.e., based on) the G&G data.

Moreover, the present disclosure contemplates that, in one embodiment, the output signal(s) can be based solely on normalization of the reference signal(s) with respect to (i.e., based on) the completion data.

In one embodiment, the output signal(s) can be communicated to the third module from the second module for further transmission from the apparatus to the device(s). Specifically, the output signal(s) can be received by the device(s) for machine-learning based processing.

In accordance with another aspect of the disclosure, there is provided a processing method.

The processing method can be suitable for analytics based on one or both of:
geology and geophysics (G&G) based data and
completion data.

The method can include:
One or both of generating and receiving one or more input signals. The input signal(s) can include one or both of:
   geology and geophysics (G&G) based data; and
   completion data associable with a structure
one or both of generating and receiving one or more reference signals
processing the input signal(s) and the reference signal(s) by manner of one or both of:
   normalizing the reference signal(s) based on G&G data, and
   normalizing the reference signal(s) based on the completion data,
to produce one or more output signal(s) corresponding to one or more normalized reference signals.

### BRIEF DESCRIPTION OF THE DRAWINGS

Embodiments of the disclosure are described hereinafter with reference to the following drawings, in which:

FIG. 1 shows a system which can include at least one apparatus and, optionally, at least one device, according to an embodiment of the disclosure;

FIG. 2 shows the apparatus of FIG. 1 in further detail wherein one or more input signals and one or more reference signal(s) can be processed to generate/produce one or more output signals, according to an embodiment of the disclosure;

FIG. 3 shows a Sweet-Spot based Machine Learning (SSML) block diagram which can be based on further processing of the output signal(s) of FIG. 2, according to an embodiment of the disclosure;

FIG. 4a shows a completion-based Machine Learning (COMML) block diagram which can be based on further processing of the output signal(s) of FIG. 2, according to an embodiment of the disclosure;

FIG. 4b shows a graphic user interface in association with the COMML per FIG. 4a, according to an embodiment of the disclosure;

FIG. 4c shows a first example of a graphics-based output in association with the COMML per FIG. 4a, according to an embodiment of the disclosure;

FIG. 4d shows a second example of a graphics-based output in association with the COMML per FIG. 4a, according to an embodiment of the disclosure; and

FIG. 5 shows a processing method in association with the system of FIG. 1, according to an embodiment of the disclosure.

### DETAILED DESCRIPTION

The present disclosure contemplates that optimization and/or design can be achieved by manner of learning based on one or both of geology and geophysics (G&G) data and completion data, with respect to production data.

Specifically, the present disclosure contemplates that production data can be processed by manner of normalization with reference to G&G data. More specifically, production data can be normalized with respect to one or more attributes associated with G&G data. In this regard, production data can be processed, by manner of normalization-based processing, with respect to G&G data.

Additionally, the present disclosure contemplates that production data can be processed by manner of normalization with reference to completion data. Production data can be normalized with respect to one or more attributes associated with completion data. In this regard, production data can be processed, by manner of normalization-based processing, with respect to completion data.

Learning can, for example, be by manner of Artificial Intelligence based machine learning.

The present disclosure contemplates that if learning is based simply on the combination of G&G data and completion data (i.e., without normalization-based processing), there is a possibility of one data (e.g., completion data) dominating another data (e.g., G&G data). Specifically, the present disclosure contemplates the possibility that, for example, the completion data can have statistical dominance over G&G data due to the inhomogeneous characteristic associable with G&G data (i.e., leading to higher correlation in respect of completion data). With the possibility of statistical dominance, it is appreciable learning by such manner (i.e., simply based on the combination of G&G data and completion data without normalization-based processing) would not necessarily be comprehensive and/or efficient, and may not facilitate effective/comprehensive optimization and/or design.

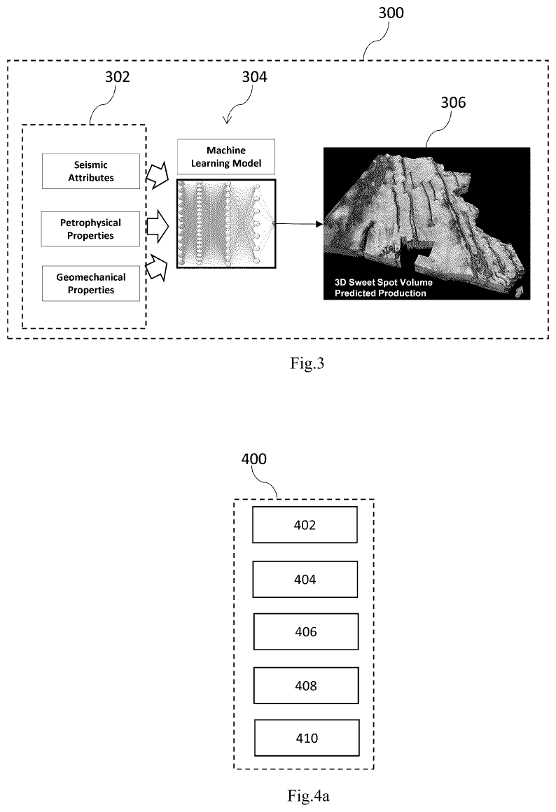

By manner of normalization-based processing in connection with G&G data, it is contemplated that the dominance of completion data can be mitigated and sweet-spot based machine learning (SSML) can be facilitated. This will be discussed later in further detail with reference to FIG. 3

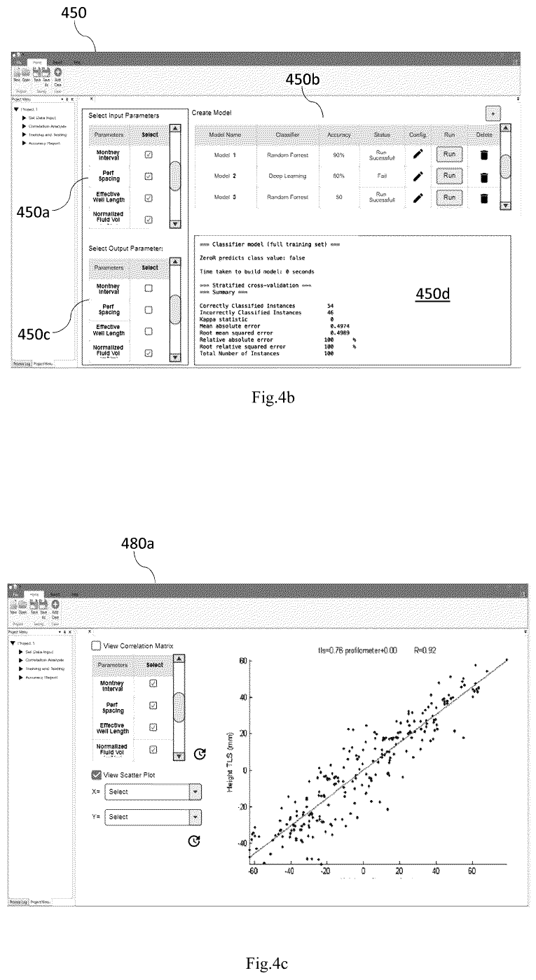

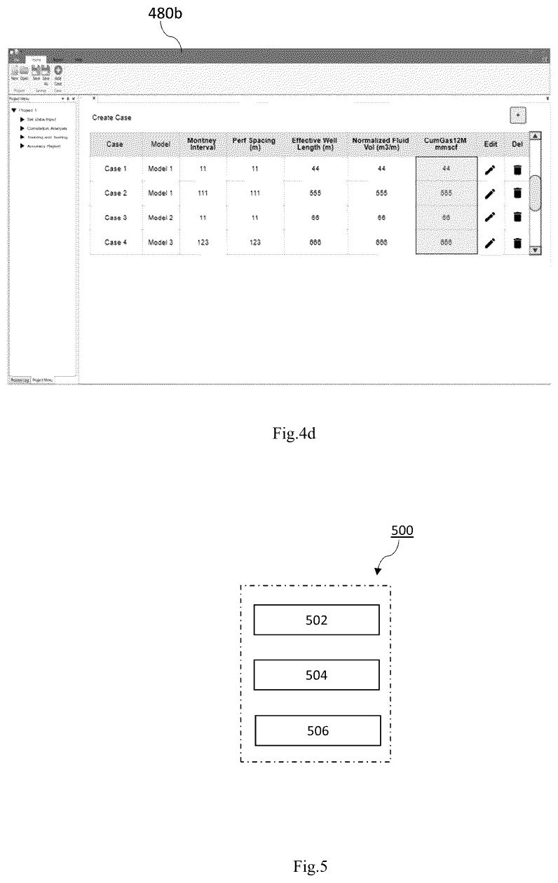

Moreover, by manner of normalization-based processing in connection with completion data, it is contemplated that the effect(s) of geological attribute(s) (i.e., attribute(s) associated with G&G data) can be mitigated. The present disclosure contemplates that this can facilitate completion-based machine learning (COMML). COMML can be associated with the prediction of production for subsequent completion designs and/or optimizing subsequent completion design(s) with corresponding production. This will be discussed later in further detail with reference to FIG. 4.

Concerning G&G data, the present disclosure contemplates that data concerning/associated with natural environment can be harvested/collected for analysis. Examples of data concerning natural environment can include physical properties of the earth, rock formation. Further examples can include in-situ rock stress, modulus of elasticity, leak-off coefficient, formation porosity. Each of the aforementioned examples with reference to G&G data can be considered to be an attribute associated with G&G data.

Concerning completion data, the present disclosure contemplates that data associated with one or more completed structures (e.g., one or more wells such as one or more oil wells) can be collected for analysis for subsequent application. Data associated with a completed structure can be referred to as completed data (e.g., a completed well can be associated with a set of completed data and another completed well can be associated with another set of completed data). In one example application, one or more sets of completed data can be used for modeling (i.e., design) of one or more subsequent structures to be constructed. Examples of completion data can include physical dimensions of a structure (e.g., a completed well) such as length and/or spacing (e.g., well length and/or well spacing), structure type (e.g., well type). Each of the aforementioned examples with reference to completion data can be considered to be an attribute associated with completion data.

Concerning production data, the present disclosure contemplates that production data can include one or more parameters associated with physical dimensions of a structure (e.g., a completed well) such as the structure length (e.g., well length). Other examples of production data can include one or more outputs associated with a structure such as pumped fluid, fluid volume, shut-in information, choke information, flowback information and conductivity information.

The foregoing will be discussed in further detail with reference to FIG. 1 to FIG. 5 hereinafter.

Referring to FIG. 1, a system 100 is shown, according to an embodiment of the disclosure. The system 100 can be suitable for analytics taking into account one or both of geology and geophysics (G&G) based data (e.g., data concerning/associated with natural environment such as physical properties of earth or rock formation) and completion data (e.g., data associated with a completed structure such as an oil well).

The system 100 can include one or more apparatuses 102 and, optionally, one or both of at least one device 104 and a communication network 106.

The apparatus(es) 102 can be coupled to the device(s) 104. Specifically, the apparatus(es) 102 can, for example, be coupled to the device(s) 104 via the communication network 106.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

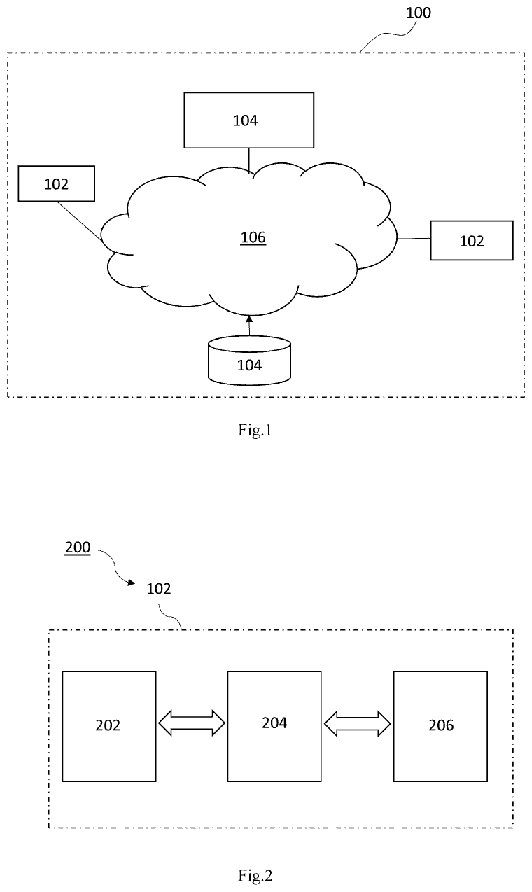

The apparatus(es) 102 can, for example, correspond to one or more computers (e.g., laptops, desktop computers and/or electronic mobile devices having computing capabilities such as Smartphones and electronic tablets). The apparatus(es) 102 can, in one embodiment, include one or more processors (not shown) which can be configured to perform one or more processing tasks which can, for example, include normalization-based processing tasks. Generally, the apparatus(es) 102 can be configured to generate and/or receive one or more input signals and process the input signal(s) in a manner so as to produce one or more output signals. The apparatus(es) 102 can be further configured to receive one or more reference signals. The reference signal(s) can be processed by manner of normalized-based processing based on the input signal(s). The input signal(s) can, for example, include one or both of G&G data and completion data. The reference signal(s) can, for example, include production data. For example, the production data can be processed by manner of normalization based on G&G data and/or completion data to generate the output signal(s). The output signal(s) can correspond to one or more normalized reference signals. The normalized reference signal(s) can, for example, include one or both of first normalized reference signal(s) (i.e., normalized based on G&G data) and second normalized reference signal(s) (i.e., normalized based on completion data). The apparatus(es) 102 will be discussed later in further detail with reference to FIG. 2, according to an embodiment of the disclosure.

The device(s) 104 can, for example, correspond to one or more host devices (e.g., one or more computers or one or more databases). A host device can, for example, be configured to host/carry a platform (software and/or hardware platform) configured to perform one or more processing tasks which can, for example, include learning-based processing tasks (e.g., machine-learning). The device(s) 104 can be configured to receive the output signal(s) for processing (e.g., machine-learning) to produce one or more prediction signals. The prediction signal(s) can be communicated from the device(s) 104 and received by, for example, the apparatus(es) 102.

The communication network 106 can, for example, correspond to an Internet communication network. Communication (i.e., between the apparatus(es) 102 and the device(s) 104) via the communication network 106 can be by manner of one or both of wired communication and wireless communication.

The aforementioned apparatus(es) 102 will be discussed in further detail with reference to FIG. 2 hereinafter.

Referring to FIG. 2, an apparatus 102 is shown in further detail in the context of an exemplary implementation 200, according to an embodiment of the disclosure.

In the exemplary implementation 200, the apparatus 102 can carry a first module 202, a second module 204 and a third module 206. The first module 202 can be coupled to one or both of the second module 204 and the third module 206. The second module 204 can be coupled to one or both of the first module 202 and the third module 206. The third module 206 can be coupled to one or both of the first module 202 and the second module 204. Coupling between the first, second and/or third modules 202/204/206 can, for example, be by manner of one or both of wired coupling and wireless coupling. Each of the first, second and third modules 202/204/206 can correspond to one or both of a hardware-based module and a software-based module, according to an embodiment of the disclosure.

In one example, the first module 202 can correspond to a hardware-based receiver which can be configured to receive one or both of the input signal(s) and the reference signal(s). In another example, the first module 202 can correspond to a graphics user interface (e.g., displayable on a screen, which is not shown, of the apparatus(es) 102) usable by a user (not shown) for generating one or more command signals which can, in turn, generate one or both of the input signal(s) and the reference signal(s). An example of a graphics user interface will be discussed later in further detail with reference to FIG. 4b.

The second module 204 can, for example, correspond to a hardware-based processor which can be configured to perform one or more normalization-based processing tasks, based on the received and/or generated input signal(s) and reference signal(s) to produce one or more output signals.

The third module 206 can correspond to a hardware-based transmitter which can be configured to transmit the output signal(s).

The present disclosure contemplates the possibility that the first and third modules 202/206 can be an integrated software-based transceiver module (e.g., an electronic part which can carry a software program/algorithm in association with receiving and transmitting functions/an electronic module programmed to perform the functions of receiving and transmitting). Moreover, it is appreciable that the aforementioned graphics user interface can be considered to be software-based.

Earlier mentioned, the second module 204 can, for example, correspond to a hardware-based processor which can be configured to perform one or more normalization-based processing tasks based on the received and/or generated input signal(s) and reference signal(s) to produce one or more output signals.

Specifically, the second module 204 can be configured to normalize production data based on G&G data. Additionally, the second module 204 can be configured to normalize production data based on completion data. Moreover, in accordance with an embodiment of the disclosure, the second module 204, if necessary, can be configured to pre-process completion data prior to normalization-based processing.

Generally, the present disclosure contemplates, in accordance with an embodiment, an apparatus 102 which can include a first module 202 which can be configured to at least one of receive at least one input signal and generate at least one input signal (i.e., receive input signal(s) and/or generate input signal(s). That is, one or both of receive at least one input signal and generate at least one input signal). The input signal(s) can include geology and geophysics (G&G) based data and completion data. Completion data can, for example, be associated with a structure (e.g., a completed structure such as a completed oil-well). The first module 202 can be further configured to at least one of receive at least one reference signal and generate at least one reference signal (i.e., receive reference signal(s) and/or generate reference signal(s). That is, one or both of receive reference signal(s) and generate reference signal(s)). The reference signal can, for example, include production data which can be associated with the structure. The apparatus 102 can further include a second module 204 which can be coupled to the first module 202. The second module 204 can be configured to process the input signal(s) and the reference signal(s) by manner of at least one of normalizing the reference signal(s) based on G&G data and normalizing the reference signal(s) based on completion data (i.e., normalizing the reference signal(s) based on G&G data and/or normalizing the reference signal(s) based on completion data) in a manner so as to produce at least one output signal corresponding to one or more normalized reference signals.

The present disclosure contemplates that, in accordance with an embodiment of the disclosure, production data can be normalized based on G&G data and completion data separately.

In one embodiment, production data can be normalized based solely on G&G data (i.e., without completion data). Specifically, production data can be normalized (i.e., normalization-based processing via, for example, second module 204) based on G&G data alone. In this regard, it is appreciable that the output signal(s) can be considered to be based solely on normalization of the reference signal(s) based on G&G data. As mentioned earlier, by manner of normalization-based processing in connection with G&G data, it is contemplated that the dominance of completion data can be mitigated and sweet-spot based machine learning (SSML) can be facilitated. This will be discussed later in further detail with reference to FIG. 3

In one embodiment, production data can be normalized based solely on completion data (i.e., without G&G data). Specifically, production data can be normalized (i.e., normalization-based processing via, for example, second module 204) based on completion data alone. In this regard, it is appreciable that the output signal(s) can be considered to be based solely on normalization of the reference signal based on completion data. As mentioned earlier, by manner of normalization-based processing in connection with completion data, it is contemplated that the effect(s) of geological attribute(s) (i.e., attribute(s) associated with G&G data) can be mitigated. The present disclosure contemplates that this can facilitate completion-based machine learning (COMML). COMML can be associated with the prediction of production for subsequent completion designs and/or optimizing subsequent completion design(s) with corresponding production. This will be discussed later in further detail with reference to FIG. 4.

Further mentioned earlier, the production data can be processed by manner of normalization based on G&G data and/or completion data to generate output signal(s). The output signal(s) can correspond to one or more normalized reference signals. The normalized reference signal(s) can, for example, include one or both of first normalized reference signal(s) (i.e., normalized based on G&G data) and second normalized reference signal(s) (i.e., normalized based on completion data).

In this regard, the output signal(s) can include one or both of first and second normalized reference signals which can be communicated to the aforementioned device(s) 104 for further processing in association with one or both of SSML and COMML respectively.

SSML will be discussed with reference to FIG. 3 hereinafter, in accordance with an embodiment of the disclosure whereas COMML will be discussed with reference to FIG. 4 later, in accordance with an embodiment of the disclosure.

Referring to FIG. 3, a block diagram 300 in association with SSML is shown, in accordance with an embodiment of the disclosure. The block diagram 300 can, for example, be representative of the aforementioned device(s) 104, in accordance with an embodiment of the disclosure.

The block diagram 300 (also referrable to as SSML block diagram 300) can, for example, include any one of an input portion 302, a processing portion 304 and an output portion 306, or any combination thereof.

In one embodiment, the SSML block diagram 300 can include an input portion 302, a processing portion 304 and an output portion 306.

The input portion 302 can be coupled to the processing portion 304. The processing portion 304 can be coupled to the output portion 306.

In one embodiment, the input portion 302 can correspond to an electronic hardware-based receiver which can be configured to receive the output signal(s) communicated from the apparatus(es) 102. Specifically, the first normalized reference signal(s) (i.e., normalized based on G&G data) can be communicated to, and received by, the input portion 302. The first normalized reference signal(s) can, for example, include/be associated with seismic attributes, petrophysical properties and/or geo-mechanical properties. The first normalized reference signal(s) can be further communicated from the input portion 302 to the processing portion 304.

In one embodiment, the processing portion 304 can correspond to an algorithm (e.g., a machine learning algorithm) capable of performing machine learning based on the received output signal(s). Specifically, based on the first normalized reference signal(s), the processing portion 304 can be configured to generate one or more prediction signals. The prediction signal(s) can be further communicated from the processing portion 304 to the output portion 306. Machine learning can, for example, be based on a neural network-based machine learning model.

In one embodiment, the output portion 306 can correspond to an electronic hardware-based transmitter which can be configured to transmit the prediction signal(s). The prediction signal(s) can be further communicated from the output portion 306 to, for example, the apparatus(es) 102. The prediction signal(s) can, for example, correspond to visually perceivable graphics-based signal(s) (e.g., displayable via an apparatus 102 which can include a display for displaying such graphics-based signal(s)) such as a three-dimensional (3D) productivity volume(s) for, for example, an entire modelled reservoir.

Moreover, the present disclosure contemplates the possibility that the input and output portions 302/306 can be an integrated software-based transceiver module (e.g., an electronic part which can carry a software program/algorithm in association with receiving and transmitting functions/an electronic module programmed to perform the functions of receiving and transmitting).

Coupling between the input, processing and/or output portions 302/304/306 can, for example, be by manner of one or both of wired coupling and wireless coupling. Each of the input, processing and/or output portions 302/304/306 can correspond to one or both of a hardware-based module and a software-based module, according to an embodiment of the disclosure.

It is contemplated that SSML can effectively integrate multi-discipline geo-engineering data, highlight key performance controlling parameters, assist identification of one or more sweet-spot(s) (e.g., which can be based on location) for future/subsequent structure (e.g., well) placement and/or strategy optimization. The identified sweet-spot(s) can be useful for providing input/consideration for optimization of future/subsequent structure (e.g., well) placement and/or improvement of production (e.g., well production). In this manner, development efficiency and/or reduction in development cost can potentially be facilitated.

It is further completed that identification of sweet-spot(s) can mitigate complication(s) arising from factors such as complicated geology and/or requirement for hydraulic fracture of reservoir. Furthermore, uncertainties such as initial well Estimated Ultimate Recovery (EUR) (which may require rigorous well decline-type curve look-back type analysis) and/or well planning to locate high productivity areas can potentially be mitigated.

Appreciably, and as mentioned earlier, the present disclosure contemplates that SSML need not utilize/is not influenced by the effects of completion data. Hence the dominance of completion data can at least be substantially mitigated, if not fully mitigated. Specifically, in respect of SSML, with the utilization of only normalized production data based on G&G data, critical contributions of geological and structure (e.g., reservoir) attribute(s) would not be overshadowed.

Further appreciably, in accordance with an embodiment of the disclosure, the SSML block diagram 300 can correspond to/be representative of a SSML type/based prediction system which utilizes normalized reference signal(s) (i.e., normalized based on G&G data) for learning (i.e., machine learning) to generate prediction signal(s) which can be indicative of one or more sweet-spot(s). In one embodiment, the SSML type/based prediction system can be suitable for the identification of one or more sweet-spots (e.g., location-based).

Generally, the present disclosure contemplates, in one embodiment, a device (e.g., the aforementioned device(s) 104) which can be suitable for sweet spot-based machine learning (SSML), the device can include an input portion 302 which can be configured to receive at least one output signal communicated from at least one apparatus 102 coupled to the device. The output signal(s) can be based on at least one production data which can be normalized based on geology and geophysics (G&G) based data. The device can further include a processing portion 304 which can be coupled to the input portion 302. The input portion 302 can be configured to process the output signal(s) by manner of machine-learning based processing to produce at least one prediction signal. The prediction signal(s) can correspond to at least one visually perceivable graphics-based signal displayable as a three-dimensional (3D) productivity volume for identifying at least one sweet spot location for the placement of a structure (e.g., a completed structure such as a completed oil-well).

As discussed earlier, in association with COMML, the output signal(s) can include/correspond to second normalized reference signals (i.e., normalized based on completion data). COMML can be associated with the prediction of production for subsequent completion designs and/or optimizing subsequent completion design(s) with corresponding production. Moreover, as discussed earlier, production data can be normalized (e.g., by manner of normalization-based processing via the second module 204) based on completion data. Moreover, completion data can be preprocessed (e.g., via the second module 204) prior to normalization-based processing, according to an embodiment of the disclosure.

COMML will be now be discussed hereinafter with reference to FIG. 4, in accordance with an embodiment of the disclosure.

Specifically, FIG. 4a shows a flow diagram 400 in association with COMML, in accordance with an embodiment of the disclosure. FIG. 4b shows an example graphics user interface (GUI) 450 which can, for example, be in association with COMML, in accordance with an embodiment of the disclosure. Moreover, FIG. 4c and FIG. 4d show examples of graphics-based output(s) in association with COMML, in accordance with an embodiment of the disclosure.

Referring to FIG. 4a, a flow diagram 400 in association with COMML is shown, in accordance with an embodiment of the disclosure. The flow diagram 400 can, for example, correspond to a COMML-based processing method. For example, the flow diagram 400 can also be referable to as a COMML-based processing method 400 (or, referrable to as processing method 400 for simplicity). In one embodiment, one or both of the aforementioned apparatus(es) 102 and the aforementioned device(s) 104 can be configured to carry an algorithm (or, in one embodiment, one or more parts of the algorithm) which, when executed, performs the step(s) (or, in embodiment, one or more steps) associated with the COMML-based processing method 400, as will be discussed in further detail hereinafter.

Specifically, the COMML-based processing method 400 can include any one of an input step 402, a preprocessing step 404, a normalization step 406 and a learning step 408, or any combination thereof, in accordance with an embodiment of the disclosure. The COMML-based processing method 400 can further include an output step 410, in accordance with an embodiment of the disclosure.

Regarding the input step 402, data associated with a completed structure (e.g., a completed well) can be received. Moreover, production data can be collected. Data associated with a completed structure can, for example, correspond to the aforementioned completion data. Earlier mentioned, the input signal(s) can, for example, include completion data and the reference signal(s) can, for example, include production data. Further mentioned earlier, the apparatus(es) 102 can be configured to receive and/or generate, and process the input signal(s) and the reference signal(s). In this regard, the apparatus(es) 102 can, at the input step 402, be configured to receive and/or generate one or both of the completion data and production data.

Regarding the preprocessing step 404, data (e.g., completion data and/or production data) received and/or generated can be preprocessed (e.g., by the apparatus(es) 102) to generate preprocessed data. For example, one or both of (received and/or generated) completion data and production data can be preprocessed by manner of any one of feature extraction, anomaly detection (detection of outliers), identification of one or more key parameter indicators, or any combination thereof. In this regard, preprocessed data can, for example, include one or both of preprocessed completion data and preprocessed production data.

Feature extraction can, for example, be in relation to extraction of an attribute/feature (e.g., well length) of a completed structure for normalization.

Anomaly detection can, for example, be in relation to a quality control process of removing/filtering outlier data (e.g., removal of data associated with shut-in) from consideration.

Identification of key parameter indicator(s) can, for example, be in relation to identification of one or more parameters considered to be of more significance (i.e., more important or to be given more weight). In one example, effective well length of a completed structure can be considered/identified to be a key parameter indicator. In another example, average proppant concentration or average slurry rate can be considered/identified to be a key parameter indicator. In another example, effective well length (of a completed structure) can be considered/identified to be of more significance as compared to average proppant concentration.

Regarding the normalization step 406, the reference signal(s) (i.e., production data) can be normalized with respect to preprocessed data. Specifically, reference signal(s) (e.g., production data) can be normalized (i.e., by manner of normalization-based processing via the apparatus(es) 102) with respect to the preprocessed data (e.g., preprocessed completion data) to produce one or more of the aforementioned output signal(s).

It is contemplated that, in one embodiment, the preprocessing step 404 can possibly be omitted. In this regard, the reference signal(s) can possibly be normalized with respect to completion data (i.e., without preprocessing) to produce one or more of the aforementioned output signal(s).

Regarding the learning step 408, the output signal(s) (i.e., normalized reference signal(s)) can be communicated (e.g., from the apparatus(es) 102 to the device(s) 104) for further processing to generate one or more prediction signals. As discussed earlier, the output signal(s) can be received by the device(s) 104 for processing by manner of learning-based processing to produce the prediction signal(s). Learning-based processing can, for example, be associated with any one of neural network based learning model, decision tree based learning model, random forest based learning model, or any combination thereof.

Regarding the output step 410, the prediction signal(s) can be communicated (e.g., from the device(s) 104 to the apparatus(es) 102) for further processing.

For example, as an option, the prediction signal(s) can be further processed for the purpose(s) of model validation (e.g., testing/validation by manner of cross-validation) and/or model evaluation and optimization. For example, the prediction signal(s) can be communicated from the device(s) 104 to the apparatus(es) 102. The apparatus(es) 102 can, for example, be further configured for validation-based processing and/or optimization-based processing of the received prediction signal(s) for, for example, model validation and/or optimization.

The present disclosure contemplates that the COMML-based processing method 400 can be associated with/correspond to a machine-learning (ML) predictive modeling tool which can be capable of utilizing a large amount of pre-processed completion data and production data. It is contemplated that such a tool can facilitate prediction of production from future/subsequent completion designs and/or optimization of completion design with corresponding production.

It is further contemplated that the COMML-based processing method 400 effectively facilitates a comprehensive data analytics workflow and/or derives one or more predictive ML models. It is appreciable that in regard to the COMML-based processing method 400, the effect(s) of G&G data can be mitigated substantially, if not mitigated completely. It is yet further contemplated that expedited analysis of data (i.e., the aforementioned large amount of pre-processed completion data and production data) can be facilitated by manner of the COMML-based processing method 400.

Generally, the present disclosure contemplates a processing method (400) in association with completion-based machine learning (COMML), in accordance with an embodiment of the disclosure. The processing method (400) can include receiving data associated with a completed structure (e.g., a completed oil-well). Data associated with the completed structure can correspond to completion (COM) data. The processing method (400) can further include collecting production data (e.g., at least one reference signal). The processing method (400) can yet further include normalizing production data based on completion (COM) data to produce at least one output signal. Moreover, processing method (400) can include processing the output signal(s) by manner of machine learning-based processing to generate at least one prediction signal. At least one predictive machine learning model can be derived based on the prediction signal(s).

Referring to FIG. 4b, a graphics user interface (GUI) 450 is shown, in accordance with an embodiment of the disclosure. The GUI 450 can, in one example, be in association with COMML. The GUI 450 can, in another example, be in association with the aforementioned first module 202.

The present disclosure contemplates that an apparatus 102 can, for example, include a display (not shown) which can be configured to show the GUI 450. The GUI 450 can include a first part 450a, a second part 450b, a third part 450c and, optionally, a fourth part 450d.

The first part 450a (e.g., “select input parameters”) can be configured to show an input interface displaying one or more input options for selection by a user (not shown). Specifically, the user can, via the first part 450a, generate one or more command signals which can, in turn, cause the apparatus 102 to, for example, generate one or more input signals (e.g., “input parameters”).

The second part 450b (e.g., “create model”) can be configured to show a model selection interface displaying one or more model options for selection by the user so that the user can specify the type of ML model desired.

The third part 450c (e.g., “select output parameter”) can be configured to show an output interface displaying one or more output options for selection by the user. The user can, via the third part 450c, generate one or more command signals which can, in turn, cause the apparatus 102 to, for example, generate one or more output signals for display. The output signals can be displayed (via the display screen of the apparatus 102) in a visually perceivable manner (i.e., graphics-based output), as will be discussed later with reference to FIG. 4c and FIG. 4d, in accordance with an embodiment of the disclosure.

The fourth part 450d can be configured to show detailed programming flow/steps in connection with the selection(s) made by the user in connection with any one of the first part 450a, the second part 450b, the third part 450c, or any combination thereof.

FIG. 4c shows a first example 480a of a graphics-based output which can be in the form of a resultant graph and FIG. 4d shows a second example 480b of a graphics-based output which can be in the form of a resultant table.

Referring to FIG. 5, a processing method 500 in association with the system 100 is shown, according to an embodiment of the disclosure.

The processing method 500 can include any one of an input receiving and/or generating step 502, a processing step 504 and an output generating step 506, or any combination thereof.

With regard to the input receiving and/or generating step 502, the aforementioned input signal(s) and/or reference signal(s) can be received and/or generated. As discussed earlier, the input signal(s) and/or the reference signal(s) can be generated and/or received by the apparatus(es) 102 for processing, according to an embodiment of the disclosure. In one example, the input signal(s) and/or the reference signal(s) can be generated by manner of the command signal(s) based on the aforementioned GUI 450. In another example, the input signal(s) and/or the reference signal(s) can be received via a receiver. In another example, the input signal(s) and the reference signal(s) can be received and/or generated via a combination of the GUI 450 (i.e., software based) and a receiver (e.g., hardware-based). In a specific example, the input signal(s) can be generated via the GUI 450 and the reference signal(s) can be received via the receiver.

With regard to the processing step 504, the input signal(s) and the reference signal(s) can be processed (i.e., by the second module 204) in a manner so as to generate/produce one or more output signal(s), as discussed earlier with reference to FIG. 2, according to an embodiment of the disclosure.

With regard to the output step 506, the output signal(s) can be communicated to the device(s) 104 for further machine learning based processing, in accordance with an embodiment of the disclosure. As discussed earlier, ML can be in the context of one or both of SSML (i.e., in association with the SSML block diagram 300, as discussed with reference to FIG. 3, in accordance with an embodiment of the disclosure) and COMML (i.e., in association with the COMML-based processing method 400, as discussed with reference to FIG. 4, in accordance with an embodiment of the disclosure).

In this regard, the present disclosure generally contemplates, in one embodiment, a processing method 500 which can be suitable for analytics based on at least one of geology and geophysics (G&G) based data and completion data (i.e., G&G data and/or completion data. That is, one or both of G&G data and completion data). The method 500 can include at least one of generating and receiving (i.e., generating and/or receiving. That is, one or both of generating and receiving) at least one input signal. The input signal(s) can include one or both of G&G data and completion data. Completion data can be associated with a structure (e.g., a completed structure such as a completed oil-well). The processing method 500 can further include one or both of generating and receiving (i.e., generating and/or receiving) at least one reference signal. The processing method 500 can yet further include processing the input signal(s) and the reference signal(s) by manner of one or both of normalizing the reference signal(s) based on G&G data and normalizing the reference signal(s) based on completion data (i.e., normalizing the reference signal(s) based on G&G data and/or normalizing the reference signal(s) based on completion data. That is, at least one or normalizing the reference signal(s) based on G&G data and normalizing the reference signal(s) based on completion data), in a manner so as to produce at least one output signal corresponding to one or more normalized reference signals.

It should be further appreciated by the person skilled in the art that variations and combinations of features described above, not being alternatives or substitutes, may be combined to form yet further embodiments.

In one example, although the aforementioned GUI 450 is generally discussed in the context of COMML, it is appreciable that one or portions (e.g., the first part 450a and the third part 450c) of the discussion concerning the GUI 450 can also be applicable in the context of SSML, according to an embodiment of the disclosure.

In another example, although not explicitly discussed, it is appreciable that the GUI 450 can include one or more other parts. For example, the GUI 450 can further include an additional part in association with generating one or more reference signals.

In yet another example, the device(s) 104 can be distinct (i.e., separate) from the apparatus(es) 102, according to an embodiment of the disclosure. In another embodiment, the device(s) 104 can be integral with the apparatus(es) 102 (e.g., a device 104 can be another module of an apparatus 102).

In yet a further example, the device(s) 104 can be one or both of hardware-based (e.g., a host device, as discussed earlier) and software-based (e.g., an algorithm/a software module carried by an apparatus 102).

In yet an additional further example, it is earlier mentioned that the output portion 306 can correspond to an electronic hardware-based transmitter which can be configured to transmit the prediction signal(s). It is contemplated that the output portion 306 can correspond to a display part (e.g., a display screen) which can be configured to display the prediction signal(s).

In yet another additional further example, the communication network 106 can be omitted, and the apparatus(es) 102 and the device(s) can be directly coupled (i.e., without the communication network 106) by manner of one or both of wired coupling and wireless coupling.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

What is claimed:

1. An apparatus comprising:
a first module configurable to:
at least one of receive at least one input signal and generate at least one input signal, the input signal including:
geology and geophysics (G&G) based data; and
completion data associable with a structure,
at least one of receive at least one reference signal and generate at least one reference signal; and
a second module coupled to the first module, the second module configurable to process the input signal and the reference signal by manner of at least one of:
normalizing the reference signal based on G&G data, and
normalizing the reference signal based on completion data,
to produce at least one output signal corresponding to at least one normalized reference signal.

2. The apparatus of claim 1 further comprising:
a third module coupled to the second module, the output signal being communicable to the third module from the second module for further transmission from the apparatus to at least one device coupled to the apparatus,
wherein the output signal is receivable by the device for machine-learning based processing.

3. The apparatus of claim 1, wherein the output signal is based solely on normalization of the reference signal based on G&G data.

4. The apparatus of claim 1, wherein the output signal is based solely on normalization of the reference signal based on completion data.

5. The apparatus of claim 1, wherein the reference signal includes production data associable with the structure.

6. The apparatus of claim 1, wherein the structure corresponds to a completed structure such as a completed oil-well.

7. A processing method suitable for analytics based on at least one of geology and geophysics (G&G) based data and completion data, the method comprising:
at least one of generating and receiving at least one input signal, the input signal including at least one of:
geology and geophysics (G&G) based data; and
completion data associable with a structure;
at least one of generating and receiving at least one reference signal;
processing the input signal and the reference signal by manner of at least one of:
normalizing the reference signal based on G&G data, and
normalizing the reference signal based on completion data,
to produce at least one output signal corresponding to at least one normalized reference signal.
